(19) United States
(12) Patent Application Publication
(10) Pub. No.: US 2022/0253609 A1
(43) Pub. Date: Aug. 11, 2022

(54) Social Agent Personalized and Driven by User Intent

(71) Applicant: Disney Enterprises, Inc., Burbank, CA (US)

(72) Inventors: Sanchita Tiwari, Trumbull, CT (US); Xiuyang Yu, Unionville, CT (US); Justin Ali Kennedy, Norwell, MA (US); Brian Kazmierczak, Hamden, CT (US); Dirk Van Dall, Shelter Island, NY (US)

(73) Assignee: Disney Enterprises, Inc.

(21) Appl. No.: 17/170,663

(22) Filed: Feb. 8, 2021

(51) Int. Cl. G06F 40/35; G06F 40/284; G06F 16/2457; G06N 3/04; G06N 3/08

(52) U.S. Cl. CPC G06F 40/35; G06F 40/284; G06F 3/167; G06N 3/0454; G06N 3/088; G06F 16/24575

(57) ABSTRACT

A system includes a computing platform having one or more processor(s) configured to receive input data corresponding to an interaction with a user, to determine a character archetype, an intent, and a sentiment of the user, to generate, using the input data and the character archetype, an output data that includes a token describing a payload, and to identify, using the token, a database corresponding to the payload. The processor(s) are further configured to obtain, by searching the database based on the character archetype, the intent, and the sentiment of the user, the payload from the database, to transform, using the character archetype and the intent and the sentiment of the user, the output data and the payload to a response to the interaction, and to render the response using a social agent that assumes the character archetype.

### BACKGROUND

A characteristic feature of human social interaction is variety of expression. For example, even when two people interact repeatedly in a similar manner, such as greeting one another, many different expressions may be used despite the fact that a simple “hello” would be adequate in almost every instance. Instead, human beings are likely to substitute “good morning.” “good evening.” “hi.” “how's it going.” or any of a number of other expressions, for “hello,” depending on the context and the circumstances surrounding the interaction, as well as the personality and intent of the speakers. For example, a human speaker may select expressions for use in an interaction with another person based on whether that person is a child, a teenager, or an adult. In order for a non-human social agent to engage in a realistic interaction with a user, it is desirable that the non-human social agent also be capable of varying its form of expression in a seemingly natural way.

However, creating a new persona for assumption by a social agent where no scripts or prior conversations exist is a challenging undertaking. Human editors must typically generate such personas manually based on basic definitions of the personalities provided to them, such as whether the persona is timid, adventurous, gregarious, funny, or sarcastic, for example. Due to such intense reliance on human involvement, prior approaches to the generation of a new persona for a social agent tend to be time-consuming and undesirably costly.

### BRIEF DESCRIPTION OF THE DRAWINGS

FIG. 1 shows a diagram of a system providing a social agent that may be personalized and driven by user intent, according to one exemplary implementation;

FIG. 2A shows a more detailed diagram of an input module suitable for use in the system of FIG. 1, according to one implementation;

FIG. 2B shows a more detailed diagram of an output module suitable for use in the system of FIG. 1, according to one implementation;

FIG. 3 is a diagram depicting a dialogue processing pipeline implemented by software code executed by the system in FIG. 1, according to one implementation;

FIG. 4A shows a flowchart presenting an exemplary method for use by a system providing a social agent that may be personalized and driven by user intent, according to one implementation; and

FIG. 4B shows a flowchart presenting a more detailed representation of a process for generating output data for use in responding to an interaction with the user, according to one implementation.

### DETAILED DESCRIPTION

The following description contains specific information pertaining to implementations in the present disclosure. One skilled in the art will recognize that the present disclosure may be implemented in a manner different from that specifically discussed herein. The drawings in the present application and their accompanying detailed description are directed to merely exemplary implementations. Unless noted otherwise, like or corresponding elements among the figures may be indicated by like or corresponding reference numerals.

As stated above, a characteristic feature of human social interaction is variety of expression. For example, even when two people interact repeatedly in a similar manner, such as greeting one another, many different expressions may be used despite the fact that a simple “hello” would be adequate in almost every instance. Instead, human beings are likely to substitute “good morning,” “good evening,” “hi.” “how's it going,” or any of a number of other expressions, for “hello,” depending on the context and the circumstances surrounding the interaction, as well as the personality and intent of the speakers. In order for a non-human social agent to engage in a realistic interaction with a user, it is desirable that the non-human social agent also be capable of varying its form of expression in a seemingly natural way that can be adapted in real-time based on one or more of the age, gender, and express or inferred preferences of the user. Consequently, there is a need in the art for an automated approach to generating dialogue for different personas each driven to be responsive to the intent of the human user with which it interacts, and each having a characteristic personality and pattern of expression that can be adapted in real-time based on one or more of the age, gender, and express or inferred preferences of the human user.

The present application is directed to automated systems and methods that address and overcome the deficiencies in the conventional art. The inventive concepts disclosed in the present application advantageously enable the automated determination of naturalistic expressions for use by a social agent in responding to an interaction with a user. In some implementations, such a response may be an intent-driven personified response or a personalized and intent-driven personified response. It is noted that, as defined in the present application, the term “response” may refer to language based expressions, such as a statement or question, or to non-verbal expressions. Moreover, the term “non-verbal expression” may refer to vocalizations that are not language based, i.e., non-verbal vocalizations, as well as to physical gestures and postures. Examples of non-verbal vocalizations may include a sigh, a murmur of agreement or disagreement, or a giggle, to name a few.

It is further noted that, as defined in the present application, an “intent-driven personified response” refers to a response based on an intent of the user, a sentiment of the user, and a character archetype to be assumed by the social agent. In addition, a response based on one or more attributes of the user, such as the age, gender, or express or inferred preferences of the user, as well as on the intent of the user, the sentiment of the user, and the character archetype to be assumed by the social agent is hereinafter referred to as a “personalized and intent-driven personified response.” In the context of natural language processing, and as used herein, the terms “intent” and “sentiment” may refer to intents determined through “intent classification.” and sentiments determined through “sentiment analysis,” respectively. For example, for language that is processed as text, the text may be classified as being associated with a specific purpose or goal (intent), and may further be classified as being associated with a particular subjective opinion or affective state (sentiment).

It is also noted that, as defined in the present application, the feature “character archetype” refers to a template or other representative model providing an exemplar for a particular personality type. That is to say, a character archetype may be affirmatively associated with some personality traits while being dissociated from others. By way of example, the character archetypes “hero” and “villain” may each be associated with substantially opposite traits. While the heroic character archetype may be valiant, steadfast, and honest, the villainous character archetype may be unprincipled, faithless, and greedy. As another example, the character archetype “sidekick” may be characterized by loyalty, deference, and perhaps irreverence.

Furthermore, as defined in the present application, the expression “foreign language” refers to a language other than the primary language in which a dialogue between a user and a social agent is conducted. That is to say where most words uttered by a user in interaction with the social agent are in the same language, that language is the primary language in which the dialogue is conducted, and any word or phrase in another language is defined to be a foreign language word or phrase. As a specific example, where an interaction between the user and the social agent is conducted primarily in English, a French word or phrase uttered during the dialogue is a foreign language word or phrase.

As defined in the present application, the terms “automation,” “automated,” and “automating” refer to systems and processes that do not require human intervention. The present systems are configured to receive an initial limited conversation sample from a user, to learn from that conversation sample, and to, based on the learning, to automatically identify a one or more generic responses to the user, and transform the generic response or responses to personalized intent-driven personified responses for use in interaction with the user. Although in some implementations a human editor may review the personalized intent-driven personified responses generated by the systems and using the methods described herein, that human involvement is optional. Thus, the methods described in the present application may be performed under the control of hardware processing components of the disclosed automated systems.

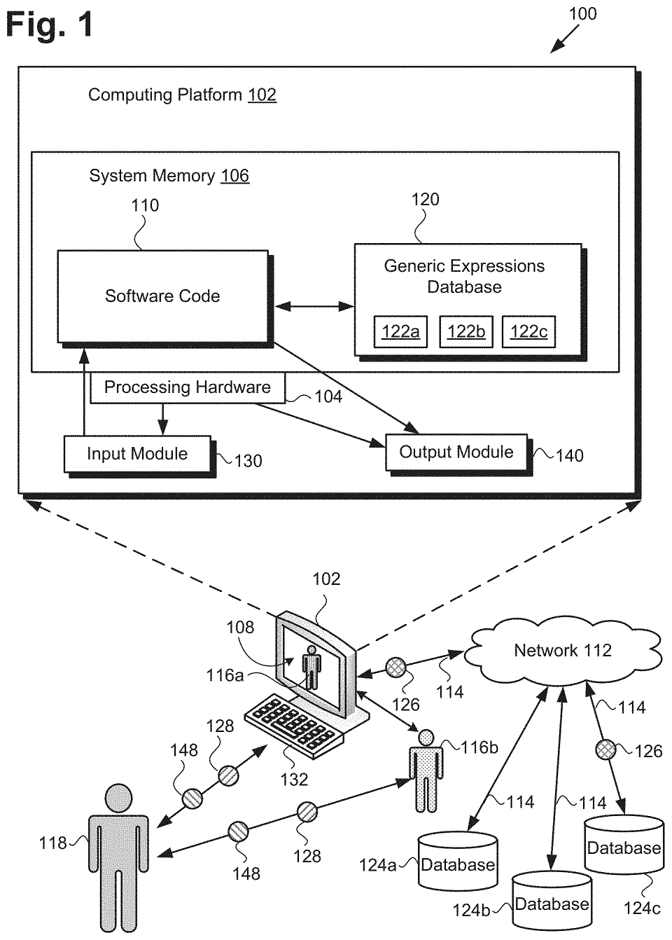

In addition, as defined in the present application, the term “social agent” refers to a non-human communicative entity rendered in hardware and software that is designed for goal oriented expressive interaction with a human user. In some use cases, a social agent may take the form of a goal oriented virtual character rendered on a display (i.e., social agent 116a rendered on display 108, in FIG. 1) and appearing to watch and listen to a user in order to respond to a communicative user input. In other use cases, a social agent may take the form of a goal oriented machine (i.e., social agent 116b, in FIG. 1), such as a robot for example, appearing to watch and listen to the user in order to respond to a communicative user input. Alternatively, a social agent may be implemented as an automated voice response (AVR) system, or an interactive voice response (IVR) system, for example.

Moreover, as defined in the present application, the term neural network (NN) refers to one or more machine learning engines implementing respective predictive models designed to progressively improve their performance of a specific task. As known in the art, a “machine learning model” may refer to a mathematical model for making future predictions based on patterns learned from samples of data or “training data.” Various learning algorithms can be used to map correlations between input data and output data. These correlations form the mathematical model that can be used to make future predictions on new input data. Moreover, a “deep neural network,” in the context of deep learning, may refer to an NN that utilizes multiple hidden layers between input and output layers, which may allow for learning based on features not explicitly defined in raw data. As used in the present application, any feature identified as an NN refers to a deep neural network. In various implementations, NNs may be trained as classifiers and may be utilized to perform image processing or natural-language processing.

FIG. 1 shows a diagram of system 100 providing a social agent that may be personalized and driven by user intent, according to one exemplary implementation. As shown in FIG. 1, system 100 includes computing platform 102 having processing hardware 104, input module 130 including input device 132, output module 140 including display 108, and system memory 106 implemented as a non-transitory storage device. According to the present exemplary implementation, system memory 106 stores software code 110 and generic expressions database 120 storing generic expressions 122a, 122b, and 122c (hereinafter “generic expressions 122a-122c”). In addition, FIG. 1 shows social agents 116a and 116b instantiated by software code 110, when executed by processing hardware 104.

As further shown in FIG. 1, system 100 is implemented within a use environment including communication network 112 providing network communication links 114, payload databases 124a, 124b, and 124c (hereinafter “payload databases 124a-124c”), payload 126, and user 118 in communication with social agent 116a or 116b. Also shown in FIG. 1 are input data 128 corresponding to an interaction with social agent 116a or 116b, as well as response 148, which may be an intent-driven personified response or a personalized and intent-driven personified response, rendered using social agent 116a or 116b.

It is noted that each of payload databases 124a-124c may correspond to a different type of payload content. For example, payload database 124a may be a database of jokes, payload database 124b may be a database of quotations, and payload database 124c may be a database of inspirational phrases. Moreover, although the exemplary implementation shown in FIG. 1 depicts three payload databases 124a-124c, that representation is provided merely for conceptual clarity. In other implementations, system 100 may be communicatively coupled to more than three payload databases via communication network 112 and network communication links 114. For example, in some implementations, payload databases 124a-124c may include one or more databases including words and phrases in a variety of spoken languages foreign to the primary language on which an interaction between user 118 and one of social agents 116a or 116b is based.

Although the present application may refer to one or both of software code 110 and generic expressions database 120 as being stored in system memory 106 for conceptual clarity, more generally, system memory 106 may take the form of any computer-readable non-transitory storage medium. The expression “computer-readable non-transitory storage medium,” as defined in the present application, refers to any medium, excluding a carrier wave or other transitory signal that provides instructions to processing hardware 104 of computing platform 102. Thus, a computer-readable non-transitory medium may correspond to various types of media, such as volatile media and non-volatile media, for example. Volatile media may include dynamic memory, such as dynamic random access memory (dynamic RAM), while non-volatile memory may include optical, magnetic, or electrostatic storage devices. Common forms of computer-readable non-transitory media include, for example, optical discs, RAM, programmable read-only memory (PROM), erasable PROM (EPROM), and FLASH memory.

It is further noted that although FIG. 1 depicts software code 110 and generic expressions database 120 as being co-located in system memory 106, that representation is also merely provided as an aid to conceptual clarity. More generally, system 100 may include one or more computing platforms 102, such as computer servers for example, which may be co-located, or may form an interactively linked but distributed system, such as a cloud-based system, for instance. As a result, processing hardware 104 and system memory 106 may correspond to distributed processor and memory resources within system 100.

Processing hardware 104 may include multiple hardware processing units, such as one or more central processing units and one or more graphics processing units. By way of definition, as used in the present application, the terms “central processing unit” (CPU) and “graphics processing unit” (GPU) have their customary meaning in the art. That is to say, a CPU includes an Arithmetic Logic Unit (ALU) for carrying out the arithmetic and logical operations of computing platform 102, as well as a Control Unit (CU) for retrieving programs, such as software code 110, from system memory 106. A GPU may be implemented to reduce the processing overhead of the CPU by performing computationally intensive graphics or other processing tasks.

In some implementations, computing platform 102 may correspond to one or more web servers, accessible over a packet-switched network such as the Internet, for example. Alternatively, computing platform 102 may correspond to one or more computer servers supporting a private wide area network (WAN), local area network (LAN), or included in another type of limited distribution or private network. Consequently, in some implementations, software code 110 and generic expressions database 120 may be stored remotely from one another on the distributed memory resources of system 100.

Alternatively, when implemented as a personal computing device, computing platform 102 may take the form of a desktop computer, as shown in FIG. 1, or any other suitable mobile or stationary computing system that implements data processing capabilities sufficient to support connections to communication network 112, provide a user interface, and implement the functionality ascribed to computing platform 102 herein. For example, in other implementations, computing platform 102 may take the form of a laptop computer, tablet computer, or smartphone, for example, providing display 108. Display 108 may take the form of a liquid crystal display (LCD), a light-emitting diode (LED) display, an organic light-emitting diode (OLED) display, a quantum dot (QD) display, or a display using any other suitable display technology that performs a physical transformation of signals to light.

It is also noted that although FIG. 1 shows input module 130 as including input device 132, output module 140 as including display 108, and both input module 130 and output module 140 as residing on computing platform 102, those representations are merely exemplary as well. In other implementations including an all-audio interface, for example, input module 130 may be implemented as a microphone, while output module 140 may take the form of a speaker. Moreover, in implementations in which social agent 116b takes the form of a robot or other type of machine, input module 130 and output module 140 may be integrated with social agent 116b rather than with computing platform 102. In other words, in some implementations, social agent 116b may include input module 130 and output module 140.

Although FIG. 1 shows user 118 as a single user, that representation too is provided merely for conceptual clarity. More generally, user 118 may correspond to multiple users concurrently engaged in communication with one or both of social agents 116a and 116b via system 100.

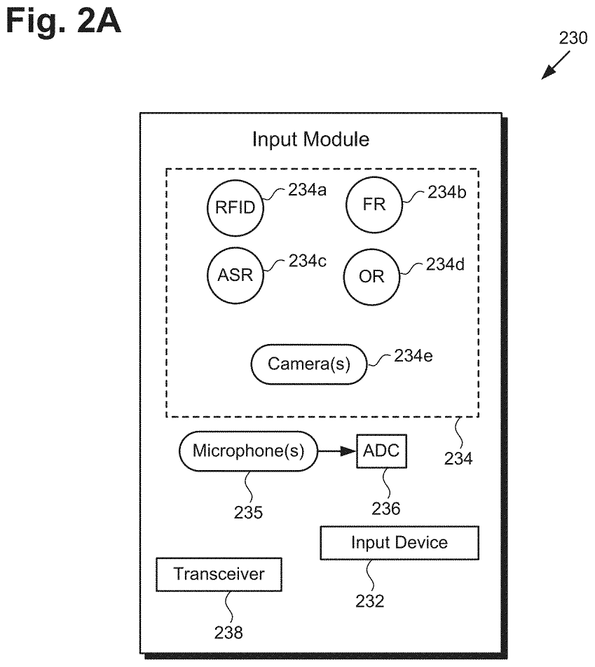

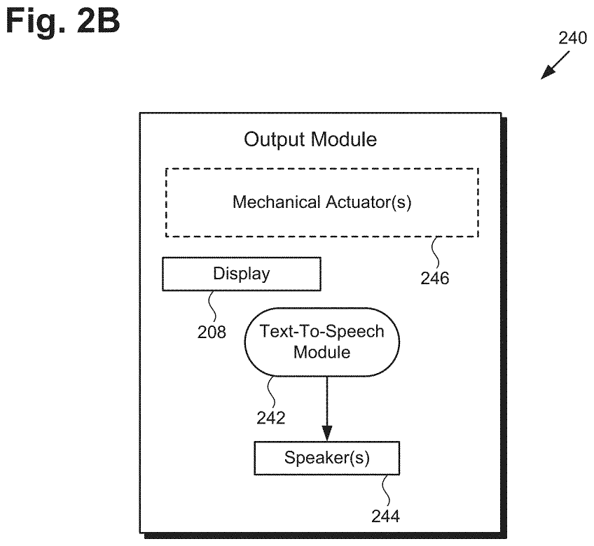

FIG. 2A shows a more detailed diagram of input module 230 suitable for use in system 100, in FIG. 1, according to one implementation. As shown in FIG. 2A, input module 230 includes input device 232, sensors 234, one or more microphones 235 (hereinafter “microphone(s) 235”), analog-to-digital converter (ADC) 236, and may include transceiver 238. As further shown in FIG. 2A, sensors 234 of input module 230 may include radio-frequency identification (RFID) sensor 234a, facial recognition (FR) sensor 234b, automatic speech recognition (ASR) sensor 234c, object recognition (OR) sensor 234d, and one or more cameras 234e (hereinafter “camera(s) 234e”). Input module 230 and input device 232 correspond respectively in general to input module 130 and input device 132, in FIG. 1. Thus, input module 130 and input device 132 may share any of the characteristics attributed to respective input module 230 and input device 232 by the present disclosure, and vice versa.

It is noted that the specific sensors shown to be included among sensors 234 of input module 130/230 are merely exemplary, and in other implementations, sensors 234 of input module 130/230 may include more, or fewer, sensors than RFID sensor 234a, FR sensor 234b, ASR sensor 234c. OR sensor 234d, and camera(s) 234e. Moreover, in other implementations, sensors 234 may include a sensor or sensors other than one or more of RFID sensor 234a, FR sensor 234b, ASR sensor 234c, OR sensor 234d, and camera(s) 234e. It is further noted that camera(s) 234e may include various types of cameras, such as red-green-blue (RGB) still image and video cameras. RGB-D cameras including a depth sensor, and infrared (IR) cameras, for example.

When included as a component of input module 130/230, transceiver 238 may be implemented as a wireless communication unit enabling computing platform 102 or social agent 116b to obtain payload 126 from one or more of payload databases 124a-124c via communication network 112 and network communication links 114. For example, transceiver 238 may be implemented as a fourth generation (4G) wireless transceiver, or as a 5G wireless transceiver configured to satisfy the IMT-2020 requirements established by the International Telecommunication Union (ITU). Alternatively, or in addition, transceiver 238 may be configured to communicate via one or more of WiFi, Bluetooth, ZigBee, and 60 GHz wireless communications methods.

FIG. 2B shows a more detailed diagram of output module 240 suitable for use in system 100, in FIG. 1, according to one implementation. As shown in FIG. 2B, output module 240 includes display 208, Text-To-Speech (TTS) module 242 and one or more audio speakers 244 (hereinafter “audio speaker(s) 244”). As further shown in FIG. 2B, in some implementations, output module 240 may include one or more mechanical actuators 246 (hereinafter “mechanical actuator(s) 246”). It is noted that, when included as a component or components of output module 240, mechanical actuator(s) 246 may be used to produce facial expressions by social agent 116b, and to articulate one or more limbs or joints of social agent 116b. Output module 240 and display 208 correspond respectively in general to output module 140 and display 108, in FIG. 1. Thus, output module 140 and display may share any of the characteristics attributed to respective output module 240 and display 208 by the present disclosure, and vice versa.

It is noted that the specific components shown to be included in output module 140/240 are merely exemplary, and in other implementations, output module 140/240 may include more, or fewer, components than display 108/208, TTS module 242, audio speaker(s) 244, and mechanical actuator(s) 246. Moreover, in other implementations, output module 140/240 may include a component or components other than one or more of display 108/208. TTS module 242, audio speaker(s) 244, and mechanical actuator(s) 246.

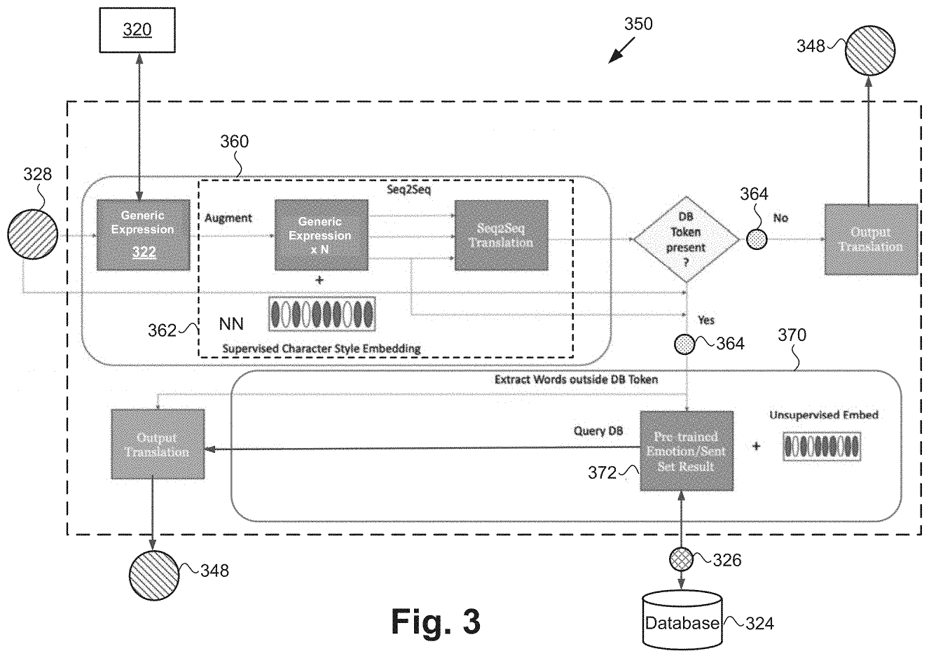

FIG. 3 is a diagram of dialogue processing pipeline 350 implemented by software code 110, in FIG. 1, and suitable for use by system 100 to produce dialogue for use by a social agent personalized and driven by user intent, according to one implementation. As shown in FIG. 3, dialogue processing pipeline 350 is configured to receive input data 328 corresponding to an interaction with a user, such as user 118 in FIG. 1, and to produce response 348 as an output. As further shown in FIG. 3, dialogue processing pipeline 350 includes generation block 360 having NN 362 configured to generate output data 364 for use in responding to user 118, as well as transformation block 370 including NN 372 fed by NN 362 of generation block 360. Also shown in FIG. 3 are generic expressions database 320, one or more generic expressions 322 (hereinafter “generic expression(s) 322”) obtained from generic expressions database 320, one or more payload databases 324 (hereinafter “payload database(s) 324”), and payload 326 obtained from payload database(s) 324.

Input data 328, generic expressions database 320, payload 326, and response 348 correspond respectively in general to input data 128, generic expressions database 120, payload 126, and response 148, in FIG. 1. Consequently, input data 328, generic expressions database 320, payload 326, and response 348 may share any of the characteristics attributed to respective input data 128, generic expressions database 120, payload 126, and response 148 by the present disclosure, and vice versa. That is to say, like response 148, response 348 may be an intent-driven personified response or a personalized and intent-driven personified response.

In addition, generic expression(s) 322, in FIG. 3, correspond in general to any one or more of generic expressions 122a-122c, in FIG. 1, while payload database(s) 324 correspond in general to any one or more of payload databases 124a-124c. Moreover, and as noted above, dialogue processing pipeline 350 is implemented by software code 110 of system 100. Thus, software code 110, when executed by processing hardware 104, may be configured to share any of the functionality attributed to dialogue processing pipeline 350 by the present disclosure.

By way of overview, and referring to FIGS. 1 and 3 in combination, input data 128/328 corresponding to an interaction with user 118 is received by dialogue processing pipeline 350, which is configured to obtain generic expression(s) 322 responsive to the interaction. Generic expression 322(s) may be augmented by NN 362, or any other suitable template generation techniques, using synonymous phrasing and optional phrase additions as described below. NN 362, for example, may then be run on each augmented sample using the network weights and character archetype embedding learned during training, as further described below, to generate output data 364 including one or more sentiment-specific expressions characteristic of a particular character archetype and, optionally, a token describing payload 126/326.

In use cases in which output data 364 generated by NN 362 contains the token describing payload 126/326, then output data 364 is passed to transformation block 370. In transformation block 370, multiple unsupervised feature extractors, for example feature extractors each focusing respectively on one of sentiment/emotion analysis, topic modeling, or character feature set, are applied to output data 364 using NN 372. These extracted features may then be used to search external payload database(s) 324 for payload 126/326, which may be one or more of a joke, a quotation, an inspirational phrase, or a foreign language word or phrase, for example. Payload 126/326 obtained from payload database(s) 324 may then be inserted into output data 364 in place of the payload token placeholder and the final result is output by dialogue processing pipeline 350 as response 148/348.

It is noted that in the specific implementations described below, response 148/348 with hereinafter be referred to as “intent-driven personified response 148/348. It is further noted that in some such implementations, intent-driven personified response 148/348 may be personalized based on various attributes of a user so as to be a personalized and intent-driven personified response. It is also noted that in use cases in which output data 364 generated by NN 362 does not include a token describing payload 126/326, intent-driven personified response 148/348 may be provided based on the one or more sentiment-specific expressions included in output data 364 from generation block 360.

### Generation Block 360:

According to the exemplary implementation shown in FIG. 3, generation block 360 includes NN 362 in the form of a Sequence To Sequence (Seq2Seq) dialogue response model including an encoder-decoder framework. In some use cases, the encoder-decoder framework of NN 362 may be implemented using a recurrent neural network (RNN), such as a long short-term memory (LSTM) encoder-decoder architecture, trained to translate generic expression(s) 322 to multiple (“N”) expressions characteristic of a particular character archetype.

In order to incorporate personality into these translations, learned character-style embeddings may be injected at each time step in the decoding process. In other words, at each time step in decoding, the target LSTM may take as input the combined representations by the target LSTM at the previous time step, the word embedding at the current time step, and the respective character archetype's style embedding learned during training. Sequential dense and softmax layers may be applied at each time step to output the next predicted word in the sequence. The next predicted word at each step may then be fed as input to the next LSTM unit.

In designing these character archetype embeddings, the objective is to learn attributes and qualities of characters archetypes such that each character archetype becomes distinguishable from every other. Besides adding additional information for use in encoding personality, this approach will additionally allow the model to be trained on less data than would otherwise be required if trained in a supervised manner solely on response data. In forming these character archetype embeddings as representations in a continuous space, the predictive model implemented by NN 362 may utilize the fact that embeddings that are located closer to some embedding than others in the continuous space will respond to interactions more similarly to those closer embedding than the more distant embeddings.

Because the objective of generation block 360 is to translate generic response templates in the form of generic expression(s) 322 to translations characteristic to a particular character archetype, the training dataset initially includes generic and translated response mappings by utterance type for several different character archetypes. To create this translated response set, generic expression(s) 322 may be manually translated to their character archetype specific counterparts. Having this training dataset for one or more character archetypes enables the mappings from generic expression(s) 322 to character-styled expressions for given character archetypes to be learned.

In order to generate more training examples, as well as along with multiple sentiment variations for each intent, augmentation techniques can be applied to generic expression(s) 322. Examples of such augmentation techniques include, but are not limited to, synonymous phrasings (e.g., would like I want), adverb insertions (e.g., +lots of), as well as miscellaneous phrase add-ons (e.g., +please?). These augmentation styles may share properties with general natural language understanding (NLU) augmentation techniques, but may be particularly targeted towards the social agent domain.

During the training process of the Seq2Seq translation model implemented by NN 362, generic expression(s) 322 are randomly matched to translated responses of the same utterance type. The same generic response can be selected to match with multiple translated responses during training. This process will train NN 362 to learn the diversity of translations that can be output for the same generic expression types by learning the underlying patterns of each utterance type. Different character archetype embeddings may be learned concurrently during the training process. For each training sample, the translation corresponding respectively to each character archetype can be used for the character archetype embedding of that sample. It is noted that, during training, generic expression(s) 322 are encoded by the encoder of NN 362 before the encoder output is decoded into a character archetype specific translation. The error can then be back propagated through the network.

During inference, as a generative model. NN 362 is configured to output multiple character archetype specific translations for the same generic expression(s). Utilizing beam search in the encoder-decoder network of NN 362, as opposed to a greedy search algorithm, it is possible to identify substantially any predetermined number of the best word predictions at each time step. For example, In order to produce multiple translated character archetype specific expressions from a single generic expression, two basic methods can be applied. The first method involves using word ontology embeddings, such as WordNet embeddings, for synonymous word insertion. The second method involves using the integration of beam search in the decoder of NN 362. At each time step of decoding, each candidate sentence can be expanded using all possible next steps and the top “k” responses may be kept (probabilistically). According to this second method, a beam size of 5, merely by way of example, will yield the 5 most likely candidate responses (after iterative probabilistic progression).

After decoding, NN 362 is configured to provide output data 364 including a predetermined number of the best translations for generic expression(s) 322. That is to say, NN 362 may be configured to generated output data 364 including one or more sentiment-specific expressions characteristic of the particular character archetype assumed by the social agent and responsive to the interaction with the user.

### Transformation Block 370:

In addition to incorporating direct Seq2Seq translation in generation block 360, dialogue processing pipeline 350 utilizes external payload database(s) 324 to obtain payload 126/326 for enhancing and personalizing intent-driven personified response 148/348. This process provides an increased level of diversity in social agent responses because the payload content that can be inserted into output data 364 are wide-ranging, and, as discussed above, may include jokes, quotations, inspirational phrases, and foreign words and phrases. The inclusion of payload 126/326 in intent-driven personified response 148/348 can be indicated through appropriate token representations in output data 364 generated by NN 362.

With respect to the insertion of payload 126/326, an encompassing payload embedding is learned by NN 372, and is used to determine the type of utterance to insert into a response based on character archetype, as opposed to merely inserting a randomly selected expression. The payload embedding concept implemented by NN 372 may include multiple facets. For example, in one implementation, payload embedding may include three facets in the form of (1) fine-grained sentiment analysis/emotion classification, (2) topic modelling, and (3) unsupervised character archetype feature extraction. In contrast to the components of generation block 360 described above, the features obtained in transformation block 370 are obtained in an unsupervised fashion. Each is applied to the entire corpus of external payload database content to provide a matching criterion for tokens included in output data 364 fed to NN 372 of transformation block 370 from NN 362 of generation block 360.

Within the overall context of dialogue processing pipeline 350, as noted above, the sentiment-specific expressions are included as translated responses in output data 364 generated by NN 362, and are received as inputs to transformation block 370 if a token is present. In that case, the feature extraction methods described above can be applied to output data 364 as well as its underlying utterance type. These features can then be mapped to the closest matching payload content within the embedding space of payload database(s) 324. The closest payload match can then be inserted into output data 364 so as to transform output data 364 and payload 126/326 to intent-driven personified response 148/348, which, as noted above, may be a personalized and intent-driven personified response.

Pre-trained fine-grained sentiment-plus-emotion classifiers may be applied to the translated responses included in output data 364 generated by NN 362 in order to ensure that intent-driven personified response 148/348, including payload 126/326 when present, substantially matches the sentiment and intent of the user along with one or more other user attributes, as defined above. For example, if the user made an angry remark, it may be undesirable for payload 126/326 to take the form of a joke. By applying these classifiers to the translated responses characteristic of a character archetype produced by generation block 360, as well as to payload content stored in payload database(s) 324, it is possible to identify an appropriate payload for inclusion in intent-driven personified response 148/348.

Topic modelling through Latent Dirichlet Allocation (LDA) and term frequency-inverse document frequency (Tf-idf) weighting may be applied to the entire collection of generic response(s) 322 and payload content stored in payload database(s) 324. The result of the LDA analysis will be a collection of N “topics” that have been identified for clustering the data. Each topic in this sense may be represented by a collection of key words and expressions that are found to compose major themes in the language data. For example, after the topics are identified in the training dataset of generic expressions and database sayings, a new translated output may be assigned to one of the generated topics. The goal is to match translated responses with payload content appropriately in terms of subject matter. As the sentiment and emotion analysis described above can identify appropriate payload 126/326 based on general mood and feeling, the addition of topic modelling here enables fuzzy-matching of payload content to translated responses included in output data 364 through commonalities in key words and topic areas. As in the sentiment and emotion component, payload content under similar topics can be thought of as being close to each other within the embedding space.

While the sentiment, emotion, and topic classifiers match translated responses characteristic of a character archetype to payload content in terms of general mood and subject matter, an additional component is needed to match payload content based on the character archetype itself. To accomplish this, a hard-coded embedding may be utilized for each character archetype, where each component of the embedding represents a given language feature. These language features can be derived from movie and television (TV) series script data and may include passive sentence ratio, the use of different pails of speech usage (e.g., the percentage of lines containing adverbs), verbosity, general sentiment (e.g., positive) and emotion (e.g., happy), as well as use of different sentence types (e.g., the ratio of exclamations to questions). With this feature set, the goal is to implement an embedding space where similar characters from perhaps different movies or TV series lie close to each other within the embedding space in terms of their manner of speaking.

Within the overall context of dialogue processing pipeline 350, character feature matching may be implemented as the final filtering step. After the given translated response characteristic of the character archetype is matched to a set of payload content by sentiment, emotion, and topic, payload 126/326 chosen for inclusion in intent-driven personified response 148/348 will represent the payload content in the embedding space closest in terms of cosine similarity to that of the given character archetype being assumed by the social agent.

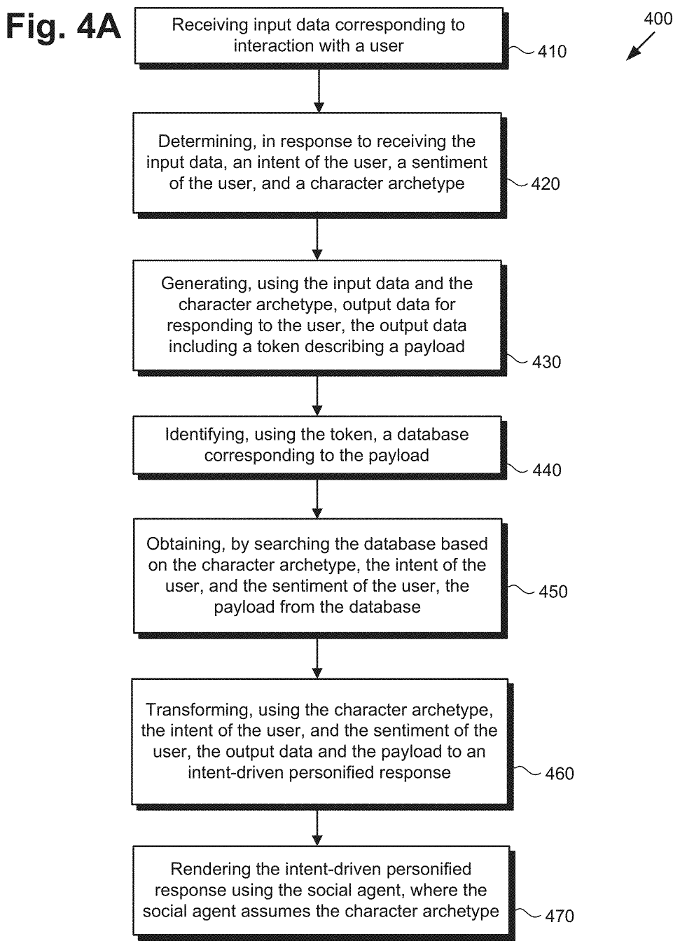

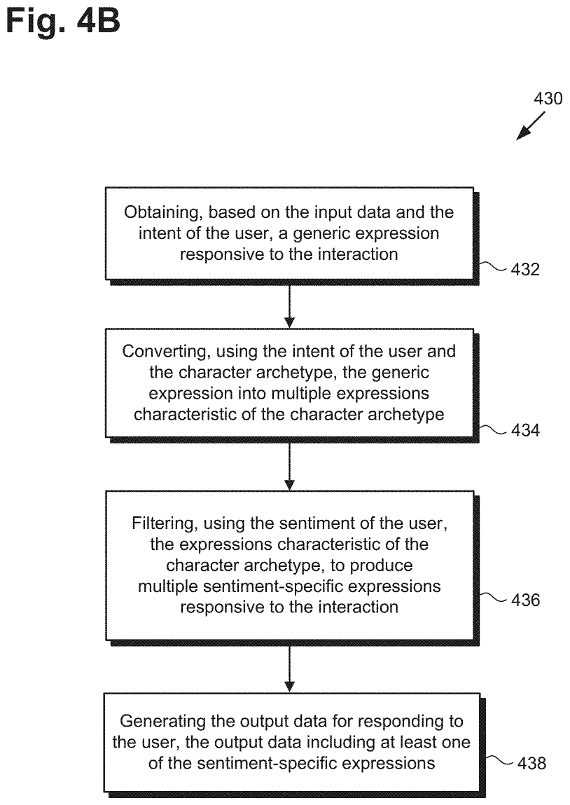

The operation of dialogue processing pipeline 350 will be further described by reference to FIGS. 4A and 4B. FIG. 4A shows flowchart 400 presenting an exemplary method for use by a system providing a social agent driven by user intent, according to one implementation, while FIG. 4B shows flowchart 430 presenting a more detailed representation of a process for generating output data 364 for use in responding to an interaction with the user, according to one implementation. With respect to the actions outlined in FIGS. 4A and 4B, it is noted that certain details and features have been left out of respective flowchart 400 and flowchart 430 in order not to obscure the discussion of the inventive features in the present application.

Referring to FIG. 4A in combination with FIGS. 1, 2A, and 3 flowchart 400 begins with receiving input data 128/328 corresponding to an interaction with user 118 (action 410). Input data 128/328 may be received by processing hardware 104 of computing platform 102, via input module 130/230. Input data 128/328 may be received in the form of verbal and non-verbal expressions by user 118 in interacting with social agent 116a or 116b, for example. As noted above, the term non-verbal expression may refer to vocalizations that are not language based, i.e., non-verbal vocalizations, as well as to physical gestures and physical postures. Examples of non-verbal vocalizations may include a sigh, a murmur of agreement or disagreement, or a giggle, to name a few. Alternatively, input data 128/328 may be received as speech uttered by user 118, or as one or more manual inputs to input device 132/232 in the form of a keyboard or touchscreen, for example, by user 118. Thus, the interaction with user 118 may be one or more of speech by user 118, a non-verbal vocalization by user 118, a facial expression by user 118, a gesture by user 118, or a physical posture of user 118.

According to various implementations, system 100 advantageously includes input module 130/230, which may obtain video and perform motion capture, using camera(s) 234e for example, in addition to capturing audio using microphone(s) 235. As a result, input data 128/328 from user 118 may be conveyed to dialogue processing pipeline 350 implemented by software code 110. Software code 110, when executed by processing hardware 104, may receive audio, video, and motion capture features from input module 130/230, and may detect a variety of verbal and non-verbal expressions by user 118 in an interaction by user 118 with system 100.

Flowchart 400 further includes determining, in response to receiving input data 128/328, an intent of user 118, a sentiment of user 118, a character archetype to be assumed by social agent 116a or 116b, and optionally one or more attributes of user 118 (action 420).

For example, based on a verbal expression, a non-verbal expression, or a combination of verbal and non-verbal expressions described by input data 128/328, processing hardware 104 may execute software code 110 to determine the intent and sentiment, or state-of-mind of user 118. For example, the intent of user 118 may be determined based on the subject matter of the interaction described by input data 128/328, while the sentiment of user 118 may be determined as one of happy, sad, angry, nervous, or excited, to name a few examples, based on input data 128/328 captured by one or more sensors 234 or microphone(s) 235 of input module 130/230 in addition to, or in lieu of, or the subject matter of the interaction.

It is noted that in some implementations, the character archetype determined in action 420 may be determined based on the subject matter of the interaction described by input data 128/328, or based on one or both of the age or gender of user 118 as determined based on sensor data gathered by input module 130/230, for example. Alternatively, or in addition, the character archetype may be identified based on an express preference of user 118, such as selection of a particular character archetype by user 118 through use of input device 132/232, or based on a preference of user 118 that is predicted or inferred by system 100. As noted above, the age, gender, express or inferred preferences of user 118 may be included among the one or more attributes of user 118 optionally determined in action 420. As further noted above, examples of character archetypes determined in action 420 may include one of a hero, a sidekick, or a villain.

Flowchart 400 further includes generating, using input data 128/328 and the character archetype determined in action 420, output data 364 for responding to user 118, where output data 364 includes a token describing payload 126/326 (action 430). Action 430 may be performed by processing hardware 104 of computing platform 102, using NN 362 of generation block 360 of dialogue processing pipeline 350, in the manner described above by reference to FIG. 3.

Flowchart 400 further includes identifying, using the token included in output data 364, a database corresponding to payload 126/326 (action 440). As noted above, the token describing payload 126/326 and included in output data 364 may identify payload 126/326 as one or more of a joke, a quotation, an inspirational phrase, or a foreign language word or phrase. Moreover, payload database(s) 324 may each be dedicated to a particular type of payload content. For example, as noted above by reference to FIG. 1, payload database 124a may be a database of jokes, payload database 124b may be a database of quotations, and payload database 124c may be a database of inspirational phrases. Action 440 may be performed by processing hardware 104 of computing platform 102, as a result of communication with payload database(s) 124a-124c/324 via communication network 112 and network communication links 114.

Flowchart 400 further includes obtaining, by searching the database identified in action 440 based on the character archetype, the intent of user 118, the sentiment of user 118, and optionally the one or more attributes of user 118, payload 126/326 from the identified database (action 450). For example, where payload 126/326 is described by the token included in output data 364 as a joke, and where payload database 124a is identified as a payload database of jokes, payload 126/326 may be obtained from payload database 124a. Alternatively, or in addition, where payload 126/326 is described by the token included in output data 364 as a quotation, and where payload database 124b is identified as a payload database of quotation, payload 126/326 may be obtained from payload database 124b, and so forth. Payload 126/326 may be obtained from payload database(s) 124a-124c/324 in action 450 by processing hardware 104 of computing platform 102, via communication network 112 and network communication links 114.

Flowchart 400 further includes transforming, using the character archetype, the intent of user 118, and the sentiment of user 118 determined in action 420, output data 364 and payload 126/326 to intent-driven personified response 148/348 (action 460). As discussed above, intent-driven personified response 148/348 represents a transformation of the multiple translated character archetype specific expressions output by NN 362, and payload 126/326 to the specific words, phrases, and sentence structures characteristic of the character archetype to be assumed by social agent 116a or 116b. For example, intent-driven personified response 148/348 may take the form of one or both of statement or a question expressed using the specific words, phrases, and sentence structures characteristic of the character archetype to be assumed by social agent 116a or 116b. Action 470 may be performed by processing hardware 104 of computing platform 102, using NN 372 of transformation block 370 of dialogue processing pipeline 350, in the manner described above by reference to FIG. 3.

Thus, as described above by reference to FIGS. 1 and 3, dialog processing pipeline 350 implemented on computing platform 102 includes a first NN, i.e., NN 362 of generation block 360, configured to generate output data 364, and a second NN fed by the first NN, i.e., NN 372 of transformation block 370, the second NN being configured to transform output data 364 and payload 126/326 to intent-driven personified response 148/348. Moreover, and as further discussed above, in some implementations, NN 362 of generation block 360 is trained using supervised learning, and NN 372 of transformation block 370 is trained using unsupervised learning.

As also noted above, in some implementations, processing hardware 102 of computing platform 104 may determine one or both of the age or gender of user 118 as based on sensor data gathered by input module 130/230. In those implementations, transforming output data 364 and payload 126/326 to intent-driven personified response 148/348 in action 460 may also use the age of user 118, the gender of user 118, or the age and gender of user 118 to personalize intent-driven personified response 148/348. For example, the character archetype being assumed by social agent 116a or 116b may typically utilize different words, phrases, or speech patterns when interacting with users with different attributes, such as age, gender, and express or inferred preferences. As another example, some expressions or payload content may be deemed too sophisticated to be appropriate for use in interactions with children.

In some implementations, flowchart 400 can continue and conclude with rendering intent-driven personified response 148/348 using social agent 116a or 116b, where social agent 116a or 116b assumes the character archetype determined in action 420 (action 470). As discussed above, intent-driven personified response 148/348 may be generated by processing hardware 104 using dialog processing pipeline 350. Intent-driven personified response 148/348 may then be rendered by processing hardware 104 using social agent 116a or 116b.

In some implementations, intent-driven personified response 148/348 may take the form of language based verbal communication by social agent 116a or 116b. Moreover, in some implementations, output module 140/240 may include display 108/208. In those implementations, intent-driven personified response 148/348 may be rendered as text on display 108/208. However, in other implementations intent-driven personified response 148/348 may include a non-verbal communication by social agent 116a or 116b, either instead of, or in addition to a language based communication. For example, in some implementations, output module 140/240 may include an audio output device, as well as display 108/208 showing an avatar or animated character as a representation of social agent 116a. In those implementations, intent-driven personified response 148/348 may be rendered as one or more of speech by the avatar or animated character, a non-verbal vocalization by the avatar of animated character, a facial expression by the avatar or animated character, a gesture by the avatar or animated character, or a physical posture adopted by the avatar or animated character.

Furthermore, and as shown in FIG. 1, in some implementations, system 100 may include social agent 116b in the form of a robot or other machine capable of simulating expressive behavior and including output module 140/240. In those implementations, intent-driven personified response 148/348 may be rendered as one or more of speech by social agent 116b, a non-verbal vocalization by social agent 116b, a facial expression by social agent 116b, a gesture by social agent 116b, or a physical posture adopted by social agent 116b.

FIG. 4B shows flowchart 430 presenting a more detailed representation of a process for generating output data 364 for use in responding to an interaction with user 118, according to one implementation. With respect to the actions outlined in FIG. 4B, it is noted that those actions, collectively, correspond in general to action 430 of flowchart 400, in FIG. 4A.

Referring to FIGS. 1 and 3 in conjunction with FIG. 4B, flowchart 430 begins with obtaining, based on input data 128/328 and the intent of user 118 determined in action 420 of flowchart 400, generic expression 322 responsive to the interaction with user 118 (action 432). Action 432 may be performed by processing hardware 104 of computing platform 102, using NN 362 of generation block 360 of dialog processing pipeline 350, in the manner described above by reference to FIG. 3.

Flowchart 430 further includes converting, using the intent of user 118 and the character archetype determined in action 420, generic expression 322 into multiple expressions characteristic of the character archetype (action 434). In some implementations, action 434 includes generating, using the intent of user 118 and generic expression 322, alternative expressions corresponding to generic expression 322 and translating, using the intent of user 118 and the character archetype determined in action 420 of flowchart 400, the alternative expressions into the multiple expressions characteristic of the character archetype. Action 434 may be performed by processing hardware 104 of computing platform 102, using NN 362 of generation block 360 of dialog processing pipeline 350, in the manner described above by reference to FIG. 3.

Flowchart 430 further includes filtering, using the sentiment of user 118 determined in action 420, the multiple expressions characteristic of the character archetype, to produce one or more sentiment-specific expressions responsive to the interaction with user 118 (action 436). Action 436 may be performed by processing hardware 104 of computing platform 102, using NN 362 of generation block 360 of dialog processing pipeline 350, in the manner described above by reference to FIG. 3.

Flowchart 430 may conclude with generating output data 364 for use in responding to user 118, output data 364 including at least one of the one or more sentiment-specific expressions produced in action 436 (action 438). Action 438 may be performed by processing hardware 104 of computing platform 102, using NN 362 of generation block 360 of dialog processing pipeline 350, in the manner described above by reference to FIG. 3. It is noted that the actions outlined by flowchart 430 may then be followed by actions 440, 450, 460, and 470 of flowchart 400.

Thus, the present application discloses automated systems and methods for providing a social agent personalized and driven by user intent that address and overcome the deficiencies in the conventional art. From a machine translation perspective, the inventive concepts disclosed in the present application differ from conventional machine translation architectures in that, rather than seeking to translate one language to another, according to the present approach both source and target sentences are of the same primary language and the translation can result in a one-to-many transformation in that language. The present inventive concepts further improve upon the state-of-the-art by introducing a transformative process that dynamically injects payload content into intent-driven personified response 148/348, and which may be personalized based in part on attributes of the user such as age, gender, and express or inferred user preferences.

The approach disclosed in the present application overcomes the failure of conventional techniques to effectively learn the sentiment of the personas they are trained on, as well as to relate better with the users by generating real-time personalized responses for interacting with the user. According to the present inventive concepts, both supervised and unsupervised components are combined in the character archetype style embeddings. Supervised components may include attributes that are learned in an end-to-end manner by the system. These supervised components of the embedding are able to learn common speaking styles and dialects. Unsupervised components may include the features utilized in the hard-coded character archetype embedding obtained from script data, such as passive sentence ratio, part of speech usage, sentence type, verbosity, tone, emotion, and general sentiment. The addition of unsupervised components to the character embeddings advantageously provide color to what otherwise may be potentially bland responses. In addition, the systems and methods disclosed herein enable machine learning using significantly less training data than is typically required in the conventional art.

Another typical disadvantage of the conventional art is the use of repetitive default responses. By contrast, the unique generative component disclosed in the present application, specifically, the insertion of intelligently selected payload content into intent-driven personified responses, permits the generation of nearly unlimited response variations in order to keep human users engaged with non-human social agents during extended interactions.

From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described herein, but many rearrangements, modifications, and substitutions are possible without departing from the scope of the present disclosure.

What is claimed is:

1. A system comprising:
a computing platform including one or more hardware processors;
the one or more hardware processors configured to:
receive input data corresponding to an interaction with a user;
determine, in response to receiving the input data, an intent of the user, a sentiment of the user, and a character archetype;
generate, using the input data and the character archetype, output data for responding to the user, the output data including a token describing a payload;
identify, using the token, a database corresponding to the payload;
obtain, by searching the database based on the character archetype, the intent of the user, and the sentiment of the user, the payload from the database;
transform, using the character archetype, the intent of the user, and the sentiment of the user, the output data and the payload to a response to the interaction; and
render the response using a social agent, wherein the social agent assumes the character archetype.

2. The system of claim 1, wherein the response is an intent-driven personified response comprising at least one of a statement or a question.

3. The system of claim 1, wherein the one or more hardware processors are further configured to:
determine, in response to receiving the input data, one or more other attributes of the user; and
wherein the payload is obtained from the database further using the one or more attributes of the user.

4. The system of claim 3, wherein the one or more attributes of the user comprise at least one of an age of the user, and gender of the user, an express preference of the user, or an inferred preference of the user.

5. The system of claim 3, wherein the response is a personalized and intent-driven personified response.

6. The system of claim 1, wherein the computing platform comprises a first neural network (NN) configured to generate the output data, and a second NN fed by the first NN, the second NN configured to transform the output data and the payload to the personalized and intent-driven personified response.

7. The system of claim 6, wherein the first NN is trained using supervised learning, and wherein the second NN is trained using unsupervised learning.

8. The system of claim 1, wherein the payload comprises at least one of a joke, a quotation, an inspirational phrase, or a foreign language word or phrase.

9. A method for use by a system including a computing platform having one or more hardware processors, the method comprising:
receiving, by the one or more hardware processors, an input data corresponding to an interaction with a user;
determining, by the one or more hardware processors in response to receiving the input data, an intent of the user, a sentiment of the user, and a character archetype;
generating, by the one or more hardware processors and using the input data and the character archetype, an output data for responding to the user, the output data including a token describing a payload;
identifying, by the one or more hardware processors and using the token, a database corresponding to the payload;
obtaining, by the one or more hardware processors by searching the database based on the character archetype, the intent of the user, and the sentiment of the user, the payload from the database;
transforming, by the one or more hardware processors and using the character archetype, the intent of the user, and the sentiment of the user, the output data and the payload to a response to the interaction; and
rendering, by the one or more hardware processors, the response using a social agent, wherein the social agent assumes the character archetype.

10. The method of claim 9, wherein the response is an intent-driven personified response comprising at least one of a statement or a question.

11. The method of claim 9 further comprising:
determining, by the one or more hardware processors in response to receiving the input data, one or more other attributes of the user, and
wherein the payload is obtained from the database further using the one or more attributes of the user.

12. The method of claim 11, wherein the one or more attributes of the user comprise at least one of an age of the user, and gender of the user, an express preference of the user, or an inferred preference of the user.

13. The method of claim 11, wherein the response is a personalized and intent-driven personified response.

14. The method of claim 9, wherein the computing platform comprises a first neural network (NN) configured to generate the output data, and a second NN fed by the first NN, the second NN configured to transform the output data and the payload to the personalized and intent-driven personified response.

15. The method of claim 14, wherein the first NN is trained using supervised learning, and wherein the second NN is trained using unsupervised learning.

16. The method of claim 9, wherein the payload comprises at least one of a joke, a quotation, an inspirational phrase, or a foreign language word or phrase.

17. A system comprising:
a computing platform including one or more hardware processors;
the one or more hardware processors configured to:
receive an input data corresponding to an interaction with a user,
determine, in response to receiving the input data, an intent of the user, a sentiment of the user, and a character archetype;
obtain, based on the input data and the intent of the user, a generic expression responsive to the interaction;
convert, using the intent of the user and the character archetype, the generic expression into a plurality of expressions characteristic of the character archetype;
filter, using the sentiment of the user, the plurality of expressions characteristic of the character archetype, to produce a plurality of sentiment-specific expressions responsive to the interaction; and
generate an output data for responding to the user, the output data including at least one of the plurality of sentiment-specific expressions.

18. The system of claim 17, wherein to convert the generic expression into the plurality of alternative expressions characteristic of the character archetype, the one or more hardware processor are further configured to:
generate, using the intent of the user and the generic expression, a plurality of alternative expressions corresponding to the generic expression; and
translate, using the intent of the user and the character archetype, the plurality of alternative expressions into the plurality of expressions characteristic of the character archetype.

19. The system of claim 17, wherein to convert the generic expression into the plurality of alternative expressions characteristic of the character archetype, one or more augmentation techniques are applied to the generic expression, and wherein the one or more augmentation techniques comprise at least one of synonymous phrasings, adverb insertions, or phrase add-ons.

20. The system of claim 19, wherein the output data further includes a token describing a payload, and wherein the one or more hardware processors are further configured to:
identify, using the token, a database corresponding to the payload;
obtain, by searching the database based on the character archetype, the intent of the user, and the sentiment of the user, the payload from the database;
transform, using the character archetype, the intent of the user, and the sentiment of the user, the output data and the payload to a response to the interaction; and
render the response using a social agent, wherein the social agent assumes the character archetype.
